(19) United States
(12) Patent Application Publication
(10) Pub. No.: US 2026/0269219 A1
(43) Pub. Date: Sep. 10, 2026

(54) Silicon-Based Anode-Active Material Having Carbon Nanotubes as the Sole Conductive Additive, And Related Electrochemical Cells and Methods

(71) Applicant: SES Holdings Pte. Ltd., Singapore (SG)

(72) Inventors: Minsung Baek, Medford, MA (US); Zhengping Zhou, Westford, MA (US); Hong Gan, Woburn, MA (US); Yineng Zhao, Woburn, MA (US); Bryce Tappan, Woburn, MA (US)

(21) Appl. No.: 19/554,330

(22) Filed: Mar. 2, 2026

Related U.S. Application Data
(60) Provisional application No. 63/768,531, filed on Mar. 7, 2025.

(51) Int. Cl. H01M 4/36; H01G 11/38; H01G 11/58; H01M 4/02; H01M 4/133; H01M 4/134; H01M 4/38; H01M 4/583; H01M 4/62

(52) U.S. Cl. CPC H01M 4/364; H01G 11/38; H01G 11/58; H01M 4/133; H01M 4/134; H01M 4/386; H01M 4/583; H01M 4/622; H01M 4/625; H01M 2004/027

(57) ABSTRACT

Silicon-based anodes having carbon nanotubes as the sole conductive additive, and related electrochemical cells and methods. Silicon-based anodes according to aspects of the present disclosures comprise a current collector, an anode-active material in electrical communication with the current collector, a plurality of carbon nanotubes electrically connecting anode-active particles of the anode-active material to one another, and a binder. In some embodiments, the carbon nanotubes comprise single-walled carbon nanotubes. In some embodiments, the carbon nanotubes comprise about 0.1 wt % to about 10 wt % of an anode-active weight. In some embodiments, the anode-active material comprises at least about 30 wt % silicon material. In electrochemical cells comprising anodes according to aspects of the present disclosure, the electrochemical cells comprise a liquid electrolyte.

### RELATED APPLICATION DATA

This application claims the benefit of priority of U.S. Provisional Application Ser. No. 63/768,531, filed Mar. 7, 2025, and titled “Silicon-Based Anode-Active Material Having Carbon Nanotubes as the Sole Conductive Additive, and Related Electrochemical Cells and Methods”, which is incorporated by reference herein in its entirety.

### FIELD OF THE INVENTION

The present invention generally relates to the field of electrochemical cells. In particular, the present invention is directed to silicon-based anode-active material having carbon nanotubes as the sole conductive additive, and related electrochemical cells and methods.

### BACKGROUND

In recent years, demand for high-performance batteries has surged, driven by the rapid growth of portable electronic devices, electric vehicles, and renewable energy storage systems. Traditional lithium-ion batteries, which have been the cornerstone of energy storage-technology, are facing limitations in terms of energy density, safety, and longevity. The anode-active material, typically made of graphite, is one of the critical components that determine a battery's overall performance. However, graphite anodes have reached their theoretical capacity limits, prompting researchers to explore silicon as an alternative anode-active material due to its high theoretical capacity.

Anodes utilizing silicon as the anode-active material, while promising, present significant challenges, including volume expansion of the silicon during cycling, which leads to continuous self-discharge and low coulombic efficiency. Conductive additives, essential for maintaining electrical conductivity in electrodes, can exacerbate these issues. Traditional carbon-based additives, such as carbon black, possess large surface areas that facilitate electron leakage. This electron leakage drives continuous solid electrolyte interphase (SEI) formation, resulting in capacity loss and reduced cycle life.

### SUMMARY OF THE DISCLOSURE

In one implementation, the present disclosure is directed to an anode, which includes a current collector; an anode-active material in electrical communication with the current collector, wherein the anode-active material comprises a plurality of anode-active particles; a conductive additive consisting of a plurality of carbon nanotubes, wherein the conductive additive electrically connects the plurality of anode-active particles to one another; and a binder binding the plurality of anode-active particles together with one another; wherein: the anode-active material comprises at least about 0.5 wt % silicon material; and the anode-active material, the conductive additive, and the binder together define an anode-active weight, and the conductive additive comprises about 0.1 wt % to about 10 wt % of the anode-active weight.

In another implementation, the present disclosure is directed to an anode, which includes a current collector; an anode-active material in electrical communication with the current collector, wherein the anode-active material comprises a plurality of anode-active particles; a conductive additive consisting of a plurality of single-walled carbon nanotubes, wherein the conductive additive electrically connects the plurality of anode-active particles to one another; and a binder binding the plurality of anode-active particles together with one another; wherein: the anode-active material comprises at least about 0.5 wt % silicon material; and the anode does not comprise any other conductive additive.

In yet another implementation, the present disclosure is directed to an electrochemical energy-storage cell, which includes an anode comprising: a current collector; an anode-active material in electrical communication with the current collector, wherein the anode-active material comprises a plurality of anode-active particles; a conductive additive consisting of a plurality of carbon nanotubes, wherein the conductive additive electrically connects the plurality of anode-active particles to one another; and a binder binding the plurality of anode-active particles together with one another; wherein: the anode-active material comprises at least about 0.5 wt % silicon material; and the anode-active material, the conductive additive, and the binder together define an anode-active weight, and the conductive additive comprises about 0.1 wt % to about 10 wt % of the anode-active weight; a cathode; a porous separator disposed between the anode and the cathode, the porous separator electrically insulating the anode and the cathode relative to one another; a container that contains the anode, the cathode, and the porous separator; and an electrolyte in contact with the anode-active material and the cathode and permeating the porous separator.

### BRIEF DESCRIPTION OF THE DRAWINGS

For the purpose of illustrating the disclosure, the drawings show aspects of one or more embodiments of the disclosure. However, it should be understood that the present disclosure is not limited to the precise arrangements and instrumentalities shown in the drawings, wherein:

FIG. 1 is a schematic representation of a conventional electrode having carbon black as an active-material-layer additive;

FIG. 2 is a schematic representation of an electrode made in accordance with aspects of the present disclosure having only CNTs as the active-material-layer additive;

FIG. 3 is a graph showing capacity retention over 1,000 cycles for three anodes made in accordance with aspects of the present disclosure; and

FIG. 4 illustrates a simplified electrochemical energy-storage cell made in accordance with aspects of the present disclosure.

### DETAILED DESCRIPTION

The entire contents of the appended claims are incorporated into this Detailed Description section as if originally presented herein.

As used herein, the term “about” when used with a corresponding numeric value refers to ±20% of the numeric value, typically ±10% of the numeric value, often ±5% of the numeric value, and most often ±2% of the numeric value. In some embodiments, the term “about” can mean the numeric value itself. In certain embodiments, where applicable, the term “about” indicates the designated value(s)±one standard deviation of that/those value(s).

As used herein, the term “silicon material” means pure silicon (such as, but not limited to, micro-size pure silicon or nano-size pure silicon), porous silicon, silicon formed from chemical vapor deposition, or any engineered silicon alloy (such as, but not limited to, silicon carbide or silicon oxide).

In some aspects, the present disclosure is directed to silicon-based anodes comprising carbon nanotubes (CNTs) as the only conductive additive. Use of CNTs as the sole conductive additive addresses the above problems in silicon-based anodes because CNTs have a significantly lower surface area and higher electric conductivity compared to traditional carbon-based additives. Instead of forming a bulk volume in the anode, as traditional carbon-based additives do, CNTs create an effective coating around the anode-active material in the anode (such as silicon), minimizing reactive surface areas and limiting SEI growth. By minimizing reactive surface areas and limiting SEI growth, coulombic efficiency, and cycling performance are improved. It is beneficial to use CNTs as the sole conductive additive rather than mixing them with one or more other conductive additives because removing other conductive additives will help reduce unwanted side reactions.

Moreover, while conventional anodes comprising silicon have been limited to having an anode-active material containing less than about 10 wt % silicon material, anodes according to aspects of the present disclosure comprise anode-active material that contains about 12 wt % to about 100 wt % silicon material. This increase in silicon material is unexpectedly enabled by using CNTs as the sole conductive additive. In embodiments wherein the anode-active material comprises less than 100 wt % silicon material, the anode-active material may also comprise carbon, such as in a graphite form. When CNTs are used as the only conductive additive, stable cycling is achieved at various silicon contents of the anode-active material, such as about 0.5 wt % to about 20 wt % silicon material, about 20 wt % to about 50 wt % silicon material, and over about 50 wt % silicon material. Even in anodes comprising anode-active material that is about 100 wt % silicon material, when CNTs are used as the only conductive additive, degradation is significantly reduced over 500 cycles under 1C/1C cycling conditions.

In addition to using CNTs as the sole conductive additive for silicon-based anodes, CNTs may also be used as the sole conductive additive for nickel-cobalt-manganese (NCM) cathodes or lithium-iron-phosphate (LFP) cathodes. Using CNTs as the sole conductive additive for NCM cathodes or LFP cathodes will yield the same benefits outlined above.

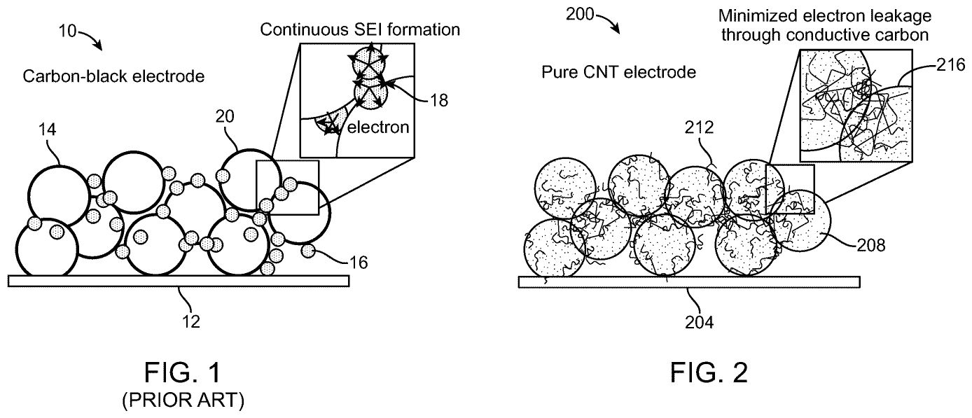

FIG. 1 shows a schematic representation of a prior-art electrode 10 having carbon black as an active-material-layer additive (hereinafter, “carbon-black electrode”). The carbon-black electrode 10 comprises a current collector 12, a plurality of anode-active particles 14 in electrical communication with the current collector, and a plurality of carbon-black particles 16 electrically connecting the anode-active particles to one another. Each of the carbon-black particles 16 possesses a large surface area that facilitates electron leakage. Electron leakage is shown by directional arrows 18. This electron leakage drives continuous formation of an SEI layer 20, which in turn causes reduced capacity and reduced cycle life.

FIG. 2 shows a schematic representation of an electrode according to aspects of the present disclosure, and particularly an electrode 200 having only CNTs as the active-material-layer additive (hereinafter, “CNT-only electrode”). The CNT-only electrode comprises a current collector 204, a plurality of anode-active particles 208 in electrical communication with the current collector, and a plurality of CNTs 212 electrically connecting the anode-particles to one another. In some embodiments, the anode-active particles 208 comprise about 0.5 wt % to about 100 wt % silicon material. In other embodiments, the anode-active particles 208 comprise at least about 12 wt % silicon material, at least about 20 wt % silicon material, at least about 30 wt % silicon material, at least about 40 wt % silicon material, at least about 50 wt % silicon material, at least about 60 wt % silicon material, at least about 70 wt % silicon material, at least about 80 wt % silicon material, or at least about 90 wt % silicon material.

The CNTs 212 in FIG. 2 have a significantly lower electrochemically active surface area than the carbon-black particles 16 in FIG. 1 due to the CNTs aggregating to cover the surface of the anode-active particles 208. When CNTs are used as the sole conductive additive as they are in the CNT-only electrode 200, they effectively electrically connect the anode-active particles 208 to one another while minimizing surface area, which both reduces electron leakage and reduces formation of an SEI layer 216 in comparison to the carbon-black electrode 10. This can be seen by the SEI layer 216 in FIG. 2 being thinner than the SEI layer 20 in FIG. 1. By minimizing reactive surface areas and limiting SEI growth, the CNT-only electrode 200 has better coulombic efficiency and cycling performance than the carbon-black electrode 10. And by not including any other conductive additive besides the CNTs 212, unwanted side reactions are reduced.

The weight ratio of the CNTs 212 to the total weight of the CNTs, anode-active particles 208, and binder (not shown) is optimized to ensure sufficient electrical conductivity without forming unnecessary bulk volume in the CNT-only electrode 200. In some embodiments, the anode-active particles 208, the CNTs 212, and the binder together define an anode-active weight, and the CNTs comprise about 0.1 wt % to about 10 wt % of the anode-active weight. In other embodiments, the anode-active particles 208 comprise about 0.1 wt % to about 3 wt % or about 1 wt % to about 2 wt % of the anode-active weight. Conventional approaches to using CNTs in silicon-based electrodes typically focus on either enhancing silicon's capacity utilization (by coupling CNTs with other conductive carbons) or using CNTs as a physical framework to encapsulate silicon (often requiring a freestanding electrode with a large amount of CNTs). In contrast, electrodes according to aspects of the present disclosure employ CNTs solely to minimize the exposed surface area of the conductive additive, thereby maximizing coulombic efficiency and cycling performance.

By exclusively using a small quantity of CNTs (such as about 0.1 wt % to about 10 wt %, or about 0.1 wt % to about 3 wt %, or about 1 wt % to about 2 wt %), the electrodes according to aspects of the present disclosure avoid unnecessary electron leakage through conductive carbon surfaces. However, the CNTs comprise at least about 0.1 wt % of the anode-active weight in order to form a sufficiently dense network that maintains electrical contact among fragmented silicon particles in liquid electrolyte systems during cycling, allowing them to remain electrochemically active. Moreover, anodes with CNTs comprising at least about 0.1 wt % of the anode-active weight unexpectedly perform better than anodes with CNTs comprising less than about 0.1 wt % of the anode-active weight in terms of rate capability, anode swelling, and cycle life. By using CNTs comprising about 0.1 wt % to about 10 wt %—and preferably about 0.1 wt % to about 3 wt % or about 1 wt % to about 2 wt %—of the anode-active weight, electrochemical side reactions are minimized while still maintaining sufficient electronic conductivity. Due to the relatively low effective surface area of CNTs compared to conventional carbon black, a robust conductive network can be achieved without excessive SEI build-up.

In some embodiments, the CNTs 212 comprise a plurality of single-walled carbon nanotubes (SWCNTs). SWCNTs are able to achieve sufficient electrical conductivity for the CNT-only electrode 200 even with minimal amounts, while also minimizing surface exposure. Use of SWCNTs therefore helps to further reduce the weight percentage of the CNTs 212.

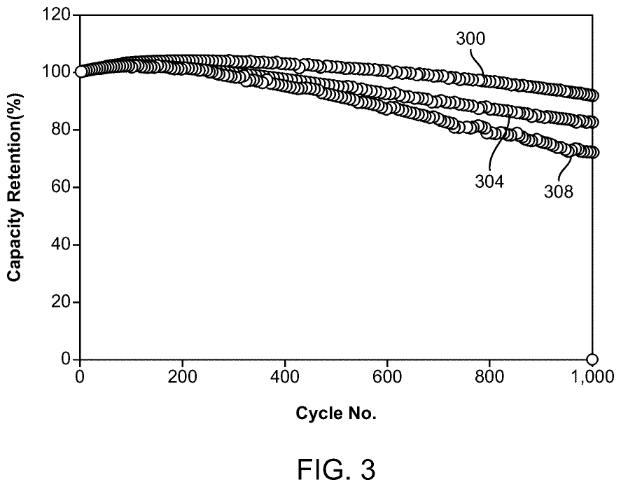

FIG. 3 is a graph showing capacity retention over 1,000 cycles for a first anode 300, a second anode 304, and a third anode 308. The first anode 300 comprised an anode-active material comprising about 12 wt % silicon carbide and about 88 wt % graphite. When contemplating the weight of the entire first anode 300 (excluding its current collector) and not just the anode-active material, the first anode comprised about 11.6 wt % silicon carbide, about 84.5 wt % graphite, about 0.4 wt % SWCNTs, about 0.6 wt % carboxy methyl cellulose (CMC) binder, about 1.5% styrene butadiene rubber (SBR) binder, and about 1.4 wt % ZEON® WX-A002 binder. The second anode 304 comprised an anode-active material comprising about 30 wt % silicon carbide and about 70 wt % graphite. When contemplating the weight of the entire second anode 304 (excluding its current collector) and not just the anode-active material, the second anode comprised about 27 wt % silicon carbide, about 63 wt % graphite, about 1.2 wt % SWCNTs, about 1.8 wt % CMC binder, about 4% SBR binder, and about 3 wt % ZEON® WX-A002 binder. The third anode 308 comprised an anode-active material comprising about 100 wt % silicon carbide and about 0 wt % graphite. When contemplating the weight of the entire third anode 308 (excluding its current collector) and not just the anode-active material, the third anode comprised about 80 wt % silicon carbide, about 0 wt % graphite, about 2.4 wt % SWCNTs, about 3.6 wt % CMC binder, about 8% SBR binder, and about 6 wt % ZEON® WX-A002 binder. Cycling conditions were 1C/1C for all three anodes that were tested. As shown in FIG. 3, even in the third anode 308 with an anode-active material comprising about 100 wt % silicon carbide, degradation was minimal over at least 500 cycles.

In some aspects, the present disclosure is directed to methods of making silicon-based anodes comprising CNTs as the only conductive additive. For example, in some embodiments, methods of making an anode comprise: mixing an anode-active material comprising at least about 0.5 wt % silicon material, a conductive additive consisting of a plurality of CNTs, a polymer binder, and a solvent to form an anode slurry; coating the anode slurry on a current collector to form the anode; and drying the anode. In some embodiments, the anode-active material, the conductive additive, and the polymer binder together define an anode-active weight, and the conductive additive comprises about 0.1 wt % to about 10 wt % of the anode-active weight. In some embodiments, each of the CNTs comprises a SWCNT. As set forth above, by not including any other conductive additive besides the CNTs, unwanted side reactions are reduced. Unlike anodes with conductive interlayers, the conductive additive is mixed with the anode-active material to form a conductive backbone within the anode-active material capable of maintaining electrical connectivity after silicon pulverization, as described in more detail below. Moreover, by not having an interlayer, methods of making silicon-based anodes according to some aspects of the present disclosure have the advantage of not requiring multiple slurry-making processes and multiple coating processes.

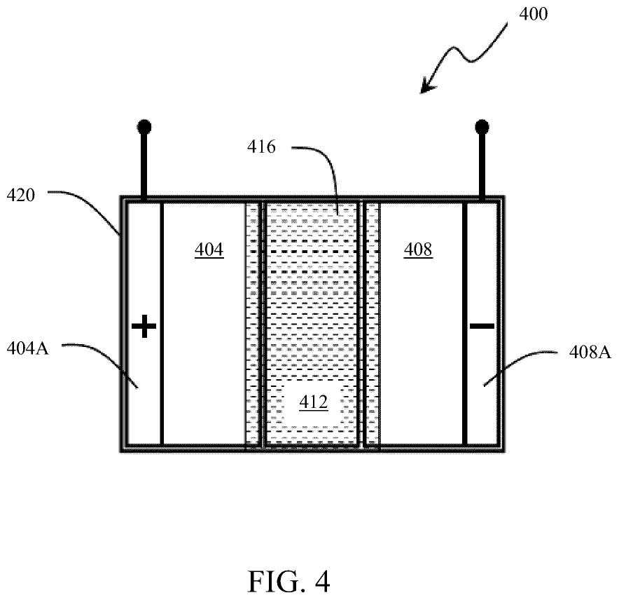

FIG. 4 illustrates a simplified electrochemical energy-storage cell 400 made in accordance with aspects of the present disclosure. Those skilled in the art will readily appreciate that the electrochemical energy-storage cell 400 can be, for example, a battery or a supercapacitor. In addition, those skilled in the art will readily understand that FIG. 4 illustrates only some basic functional components of the electrochemical energy-storage cell 400 and that a real-world instantiation of the electrochemical energy-storage cell, such as a secondary battery or a supercapacitor, will typically be embodied using either a wound construction or a stacked construction. Further, those skilled in the art will understand that the electrochemical energy-storage cell 400 will include other components, such as electrical terminals, seal(s), thermal shut-down layer(s), and/or vent(s), among other things, that, for ease of illustration, are not shown in FIG. 4.

In this example, the electrochemical energy-storage cell 400 includes a spaced-apart cathode 404 and anode 408, and a pair of corresponding respective current collectors 404A, 408A. A porous separator 412 is located between the cathode 404 and the anode 408 to electrically separate the cathode and the anode but to allow ions of an electrolyte 416 to flow therethrough. The porous separator 412 and/or one, the other, or both of the cathode 404 and the anode 408, depending on whether porous or not, is/are impregnated with the electrolyte 416. In FIG. 4, both the cathode 404 and the anode 408 are illustrated as being porous by way of the electrolyte 416 being illustrated as extending into them. The electrochemical energy-storage cell 400 includes a container 420 that contains the current collectors 404A, 408A, the cathode 404 and the anode 408, the porous separator 412, and the electrolyte 416. In some embodiments, the electrochemical energy-storage cell 400 is part of a greater battery system.

As those skilled in the art will understand, depending upon the type and design of the electrochemical energy-storage cell 400, each of the cathode 404 and the anode 408 comprises a suitable material compatible with the constituents in the electrolyte 416. The anode 408 may comprise any of the properties of anodes described above, such as comprising CNTs as the only conductive additive. In some embodiments, the anode 408 comprises at least about 0.5 wt % silicon material in its anode-active material. In other embodiments, the anode-active material comprises at least about 12 wt % silicon material, at least about 20 wt % silicon material, at least about 30 wt % silicon material, or at least about 50 wt % silicon material. In another embodiment, the anode-active material is about 100 wt % silicon material. In embodiments wherein the anode-active material comprises less than 100 wt % silicon material, the anode-active material may also comprise carbon, such as in a graphite form. Each current collector 404A, 408A may be made of any suitable electrically conducting material, such as copper or aluminum, or any combination thereof. The porous separator 412 may be made of any suitable porous dielectric material, such as a porous polymer, among others.

The electrolyte 416 comprises a liquid electrolyte. In liquid electrolyte environments, repeated silicon volume expansion readily leads to particle pulverization and detachment, resulting in electrical isolation of fragmented particles. Use of carbon nanotubes, and especially SWCNTs, allows a uniform percolated conductive network to be formed throughout the electrode bulk to reuse detached particles during a cycle, which addresses that issue in liquid electrolytes. When CNTs comprise at least about 0.1 wt % of the anode-active weight, they form a sufficiently dense network that maintains electrical contact among fragmented silicon particles in liquid electrolyte systems during cycling, allowing them to remain electrochemically active.

Use of CNTs as the only conductive additive pairs effectively with high-performance electrolytes, enabling stable performance over extended cycles, even with anodes comprising anode-active material that is about 100 wt % silicon material.

Various battery and supercapacitor constructions that can be used for constructing the electrochemical energy-storage cell 400 of FIG. 4, are known in the art. If any of such known constructions is used, a novelty of the electrochemical energy-storage cell 400 lies in the anode 408. Those skilled in the art will readily appreciate that in stacked constructions made of a plurality of anodes stacked with a plurality of cathodes and a plurality of separators, each anode may have anode-active material on both sides of the corresponding current collector 408A.

In some aspects, the present disclosure is directed to methods of manufacturing an electrochemical energy-storage cell comprising a silicon-based anode including CNTs as the only conductive additive. The electrochemical energy-storage cell and anode may have any one or more of the properties of electrochemical energy-storage cells and anodes described above. For example, in some embodiments, methods of manufacturing the electrochemical energy-storage cell 400 of FIG. 4 comprise placing the anode 408 in the container 420, placing the porous separator 412 in the container on top of the anode, placing the cathode 404 in the container on top of the porous separator, adding the electrolyte 416 to the container, and sealing the container. Placing various of these elements “on top” of each other is not meant to be limited to a particular direction in space—the electrochemical energy-storage cell may be assembled in any direction.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. An anode, comprising:
a current collector;
an anode-active material in electrical communication with the current collector, wherein the anode-active material comprises a plurality of anode-active particles;
a conductive additive consisting of a plurality of carbon nanotubes, wherein the conductive additive electrically connects the plurality of anode-active particles to one another; and
a binder binding the plurality of anode-active particles together with one another;
wherein:
the anode-active material comprises at least about 0.5 wt % silicon material; and
the anode-active material, the conductive additive, and the binder together define an anode-active weight, and the conductive additive comprises about 0.1 wt % to about 10 wt % of the anode-active weight.

2. The anode of claim 1, wherein each of the plurality of carbon nanotubes comprises a single-walled carbon nanotube.

3. The anode of claim 1, wherein the anode does not comprise any other conductive additive.

4. The anode of claim 1, wherein the anode-active material comprises at least about 30 wt % silicon material.

5. The anode of claim 1, wherein the anode-active material further comprises carbon.

6. The anode of claim 5, wherein at least some of the carbon is in a graphite form.

7. The anode of claim 1, wherein the anode-active material comprises about 100 wt % silicon material.

8. The anode of claim 1, wherein the conductive additive comprises about 0.1 wt % to about 3 wt % of the anode-active weight.

9. The anode of claim 1, wherein the binder comprises at least one of carboxy methyl cellulose and styrene butadiene rubber.

10. The anode of claim 1, wherein the conductive additive forms a conductive backbone within the anode-active material.

11. An anode, comprising:
a current collector;
an anode-active material in electrical communication with the current collector, wherein the anode-active material comprises a plurality of anode-active particles;
a conductive additive consisting of a plurality of single-walled carbon nanotubes, wherein the conductive additive electrically connects the plurality of anode-active particles to one another; and
a binder binding the plurality of anode-active particles together with one another;
wherein:
the anode-active material comprises at least about 0.5 wt % silicon material; and
the anode does not comprise any other conductive additive.

12. The anode of claim 11, wherein the anode-active material and the conductive additive together define an anode-active weight, and the conductive additive comprises about 0.1 wt % to about 10 wt % of the anode-active weight.

13. An electrochemical energy-storage cell, comprising:
an anode comprising:
a current collector;
an anode-active material in electrical communication with the current collector, wherein the anode-active material comprises a plurality of anode-active particles;
a conductive additive consisting of a plurality of carbon nanotubes, wherein the conductive additive electrically connects the plurality of anode-active particles to one another; and
a binder binding the plurality of anode-active particles together with one another;
wherein:
the anode-active material comprises at least about 0.5 wt % silicon material; and
the anode-active material, the conductive additive, and the binder together define an anode-active weight, and the conductive additive comprises about 0.1 wt % to about 10 wt % of the anode-active weight;
a cathode;
a porous separator disposed between the anode and the cathode, the porous separator electrically insulating the anode and the cathode relative to one another;
a container that contains the anode, the cathode, and the porous separator; and
an electrolyte in contact with the anode-active material and the cathode and permeating the porous separator.

14. The electrochemical energy-storage cell of claim 13, wherein the electrolyte is a liquid electrolyte.

15. The electrochemical energy-storage cell of claim 13, wherein each of the plurality of carbon nanotubes comprises a single-walled carbon nanotube.

16. The electrochemical energy-storage cell of claim 13, wherein the anode does not comprise any other conductive additive.

17. The electrochemical energy-storage cell of claim 13, wherein the anode-active material comprises at least about 30 wt % silicon material.

18. The electrochemical energy-storage cell of claim 13, wherein the anode-active material comprises about 100 wt % silicon material.

19. The electrochemical energy-storage cell of claim 13, wherein the conductive additive comprises about 0.1 wt % to about 3 wt % of the anode-active weight.

20. The electrochemical energy-storage cell of claim 13, wherein the binder comprises at least one of carboxy methyl cellulose and styrene butadiene rubber.
